(19) United States
(12) Patent Application Publication
(10) Pub. No.: US 2015/0039410 A1
(43) Pub. Date: Feb. 5, 2015

(54) Dynamic Awards and Restrictive Tender System and Method

(71) Applicant: Wal-Mart Stores, Inc., Bentonville, AR (US)

(72) Inventors: Nick RONE, Bella Vista, AR (US); Robert ABATE, Noel, MO (US); Michael ATCHLEY, Springdale, AR (US); Donald HIGH, Noel, MO (US)

(21) Appl. No.: 13/957,964

(22) Filed: Aug. 2, 2013

(51) Int. Cl. G06Q 30/02

(52) U.S. Cl. CPC G06Q 30/0222
USPC 705/14.23

(57) ABSTRACT

A dynamic awards and restrictive tender method and system are provided. The method includes receiving, at a processor of a sales device, a request for a purchase of an item. A purchase rule applicable to the purchase is determined. An update to the purchase rule is received. The request for the purchase is processed based upon the updated purchase rule. At the processor, a notification of a success or a rejection of the processed request for the purchase is provided to a requester initiating the request.

### CROSS REFERENCE TO RELATED APPLICATIONS

This application is related to U.S. patent application Ser. No. 13/632,491 entitled “UNIVERSAL SUBSTANTIATION SYSTEM,” filed Oct. 1, 2012, and to U.S. patent application Ser. No. 13/862,019 entitled “SYSTEM AND METHOD FOR FACILITATING A PURCHASE OF SELECTED PRODUCTS OR SERVICES,” filed Apr. 12, 2013, which patent applications are both incorporated by reference herein in their entireties.

### FIELD OF THE DISCLOSURE

Some aspects of the present disclosure relate generally to the field of system and method that may enable the purchase of products or services using a payment or identification device. More particularly, some aspects of the present disclosure relate to the field of dynamic awards and restrictive tender system and method.

### BACKGROUND OF THE DISCLOSURE

Conventional award and restricted tender systems and methods are fixed at the time of issuance of an instrument or a tender mechanism enabling the use of the award or the purchase. For example, a gift card available to a user may have a predetermined value and a predetermined store at which the gift card may be used. Similarly, conventional restrictive tender systems restrict or limit specific products that may be purchased using the tender mechanism. However, such tender mechanisms are fixed in nature and cannot be modified during or in-between purchases in real time for various parameters.

In view of the foregoing, there is a need for flexible or dynamic award and restrictive tender systems.

### SUMMARY OF THE DISCLOSURE

Some aspects of the present disclosure address at least the issues discussed above.

In accordance with one aspect of the present disclosure a dynamic awards and restrictive tender method is provided. The method includes receiving, at a processor of a sales device, a request for a purchase of an item. A purchase rule applicable to the purchase is determined. An update to the purchase rule is received. The request for the purchase is processed based upon the updated purchase rule. At the processor, a notification of a success or a rejection of the processed request for the purchase is provided to a requester initiating the request.

In accordance with one aspect of this disclosure, a computer readable medium storing computer executable instructions thereupon for dynamic awarding and restrictive tendering is provided. The instructions when executed by a processor cause the processor to receive a request for a purchase of an item, receive a purchase rule applicable to the request for the purchase, receive an update to the purchase rule from an account holder, process the request for the purchase based upon the updated purchase rule, and provide a notification of a success or rejection of the processed request for the purchase to the requester at a sales device.

In accordance with one aspect of this disclosure, a dynamic awards and restrictive tender system is provided. The dynamic awards and restrictive tender system includes a database. The database includes an account associated with an account holder and a rules engine. The rules engine includes a plurality of purchase rules dynamically programmable by the account holder, the rules engine configured to determine a purchase rule applicable to a request for a purchase. The dynamic awards and restrictive tender system includes a sales device configured to execute the purchase requested by a requester, the sales device including a processor configured to receive a request for a purchase of an item, receive a purchase rule applicable to the request for the purchase, receive an update to the purchase rule from an account holder, process the request for the purchase based upon the updated purchase rule, and provide a notification of a success or rejection of the processed request for the purchase to the requester at a sales device.

There has thus been outlined, rather broadly, certain aspects of the disclosure in order that the detailed description thereof herein may be better understood, and in order that the present contribution to the art may be better appreciated. There are, of course, additional aspects of the disclosure that will be described below and which will form the subject matter of the claims appended hereto.

In this respect, before explaining at least one aspect of the disclosure in detail, it is to be understood that the disclosure is not limited in its application to the details of construction and to the arrangements of the components set forth in the following description or illustrated in the drawings. The disclosure is capable of aspects in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present disclosure. It is important, therefore, that the claims be regarded as including such equivalent constructions insofar as they do not depart from the spirit and scope of the present disclosure.

### BRIEF DESCRIPTION OF THE DRAWINGS

FIG. 1 is a schematic diagram of an exemplary dynamic awards and restrictive tender system, in accordance with an aspect of the present disclosure.

FIG. 2 is a flow diagram of an exemplary dynamic awards and restrictive tender method, in accordance with an aspect of the present disclosure.

### DETAILED DESCRIPTION OF THE DRAWINGS

An aspect of the present disclosure is directed to a dynamic awards and restrictive tender (DART) system 100 that may allow account holders, such as individuals or organizations to dynamically restrict and reward an account user's purchases through a sales device (e.g., a Point of Sale (POS) device) using special tender or account type. For example, outside organizations may dynamically in real-time enter and maintain purchasing rules for items, products, and categories of products through web access, web services, and a rules based engine that may restrict or exclude items, services, or products that may be purchased by their clients, issuing parties, or account users using this special account type or tender mechanism (e.g., gift card, credit card, mobile application, etc.). Special tender may be any situation where an account number can be assigned to an individual or a group where the account number may have financial implications, for example but not limited to a gift card or a unique mobile phone application (“app”) identification. Using the DART system 100, the organization or account holder may flexibly change purchase rules associated with each special tender depending upon various parameters as discussed herein. Various aspects of the disclosure offer exemplary advantages. The DART system 100 enables outside organizations to dynamically restrict and reward their client's, issuing party's or account user's purchases through a sales device, e.g., a POS terminal, using special tender or account type effectuated by a special tender or instrument. For example, outside organizations may allow account users to use the special tender at stores such as Walmart™ to purchase special products that are restricted by various conditions (e.g., age of the account user(s)). Likewise, universities and parents may use the special tender for providing special tender in the form of a card to give to their student or child for purchasing only certain products to have institutional or parental control over purchases. Some organizations may want to dynamically restrict which products a client can purchase using this special tender (i.e., shopping card or mobile pay) by bin range. Some organizations may want to dynamically reward clients for purchasing special products by bin range. Likewise, various organizations may want an ability to freely change the items or categories of items on demand, to receive information back in the way of metrics, statistics, and raw data tracking client usage. It is to be noted that the discussion herein may pertain to a single account user but such discussion is not meant to be limiting. For example, multiple users or a group of users may be provided with a range of card numbers associated with respective special tenders.

As used herein, the term “organization” or “account holder” is related to any individual or collection of individuals that may enroll into the DART system 100 to allow authorized users to make purchases or utilize services (e.g., financial, healthcare, commuter benefits services, etc.). Such an organization or account holder may include any individual, company, corporation, partnership, association, club, foundation, agencies, organization, federal government, state or local governments, charities that may obtain the special tender or account type or other tendering instruments for the consumers. The account holder or the organization may include, but is not limited to, an entity or any other organizations that may access a financial system to obtain payment or identification devices for the consumers and create a list of products or services that may qualify for promotional rebates.

As used herein, the term “merchant” is interpreted broadly to include any individual, retail stores, retail chains, websites, financial institutions, service providers, and/or other organization that may sell products or services to consumers. Also, the merchant may include, but is not limited to, any entity that may sell products or services to users or consumers.

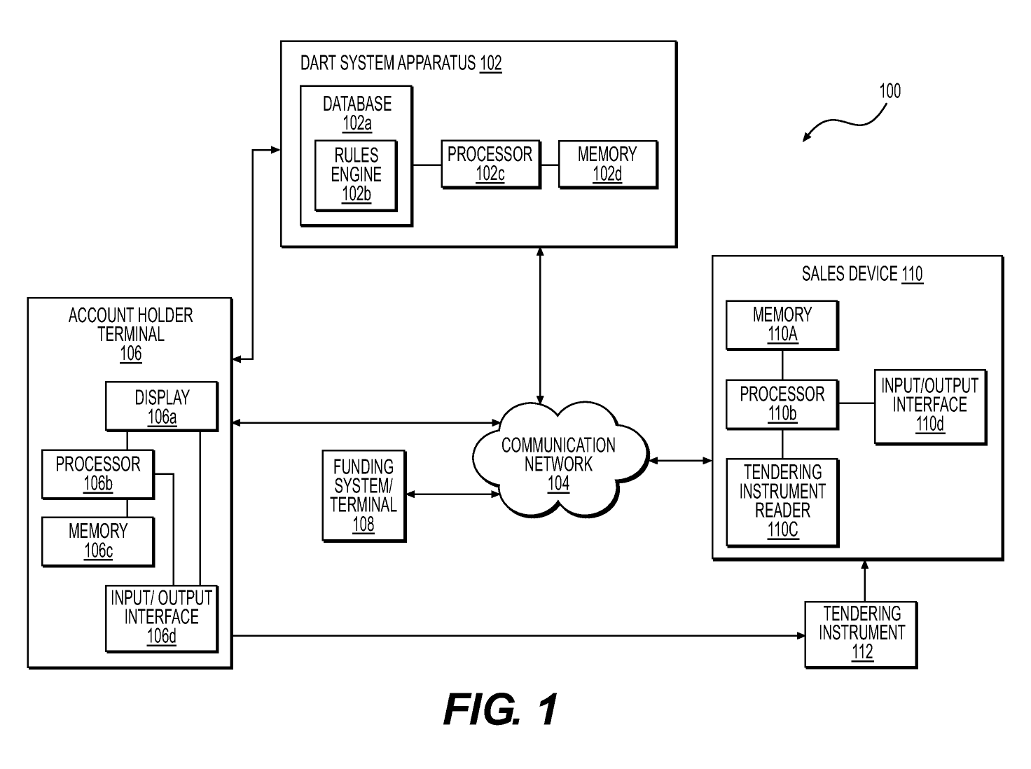

Referring now to the figures wherein like reference numbers refer to like elements, FIG. 1 shows an aspect of the DART system 100. The DART system 100 includes a DART system apparatus 102, an account holder terminal 106, a sales device 110, a funding system terminal 108, a tendering instrument 112, and a communication network 104. In one aspect, the DART system apparatus 102 and the account holder terminal 106 may be part of a single device, e.g., an integrated computer device, which implements the features and functionalities of the DART system apparatus 102 and the account holder terminal 106, as discussed herein.

The DART system apparatus 102 is, or is a part of, a computing device that implements the features and functions of the DART system 100 as discussed herein. The DART system apparatus 102 may be a hardware server including a database 102a, a processor 102c, and a memory 102d. The DART system apparatus 102 may include other standard hardware components (not shown) such as disk drives, input-output ports or interfaces, display unit(s), heat sinks and cooling systems, power supply, network cards, storage racks, etc., known to one of ordinary skill in the art.

The database 102a may be a dedicated memory device including a rules engine 102b. The database 102a may be based on a relational model. Alternatively, the database 102a may be based on models such as hierarchical, object oriented, or the like. In one aspect of the disclosure, the database 102a may be implemented or managed using one or more known database management systems such as one or more of IBM® DB2™ or Informix™, SQL Server® or MSAccess® provided by Microsoft Corporation of Redmond, Wash., an object-relational database management system produced and marketed by Oracle Corporation of Redwood Shores, Calif., etc.

The rules engine 102b includes a set of purchase rules that are initialized by an organization or an account holder at the account holder terminal 106, and may be updated at the database 102a via the account holder terminal 106. In some aspects, the rules engine 102b may be updated by other means using an external third party computer system. For example, the rules engine may be updated with the DART system apparatus 102 communicating with a computer device (not shown) that has control over when and how the purchase rules may be updated based on various parameters such as age of the account user, time stamp, availability of products for purchase, triggering events (graduation, birthdays, etc.), or the like. The purchase rules may be associated with the tendering instrument 112 provided by an account holder to a user. That is, each tendering instrument similar to the tendering instrument 112 may have its own purchase rule associated. The rules engine 102b may implement the purchase rules using known programming language stored in the memory 102d. The purchasing rules may be coded as instructions residing upon the memory 102d, which, when executed by the processor 102c, allow the DART system apparatus 102 to implement the various features and functionalities of the DART system 100 as discussed herein. The purchase rules implemented by the rules engine 102b may include one or more categories of items for purchasing, a time period for purchasing an item, a method of payment for purchasing an item, an award or a discount value associated with the purchase, a list of prohibited items that may not be purchased with the tendering instrument 112, a monetary limit imposed on a purchase, a number or quantity of items that may be purchased, or identification information for the requester (i.e., the user), or combinations thereof. In one aspect, the rules engine 102b may be implemented using standard programming languages such as C, Java, etc.

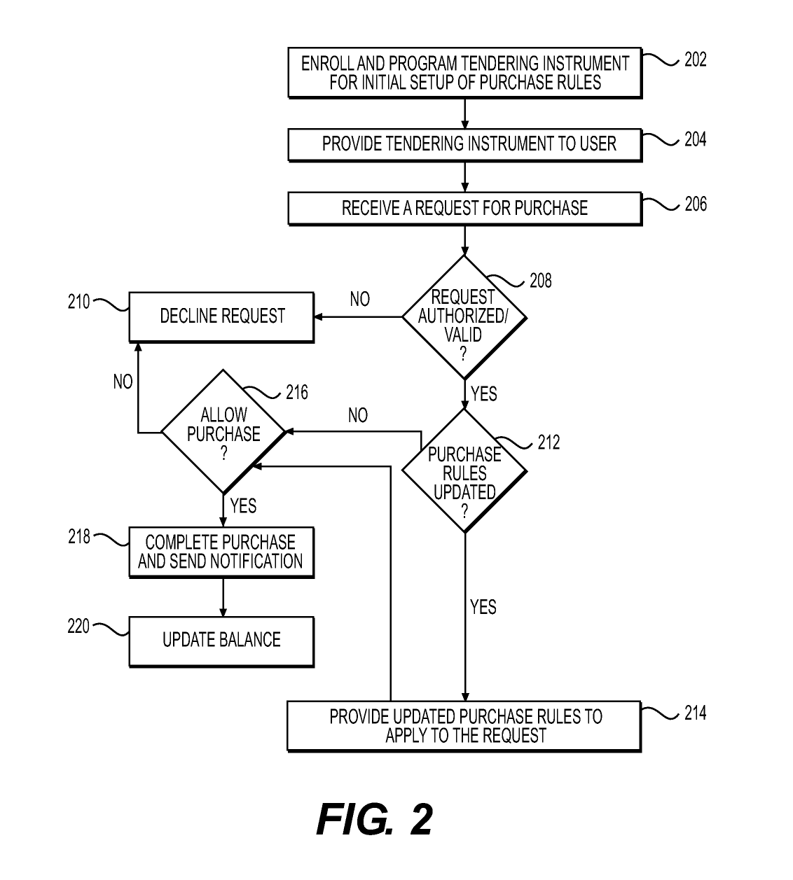

The processor 102c may be a general purpose processing unit, e.g., a microprocessor chip. The processor 102c may be configured, adapted, or programmed to receive and process code associated with the rules engine 102b in the database 102a. In addition, the processor 102c may be configured, adapted, or programmed to carry out additional steps. The processor 102c may execute one or more instructions stored in memory 102d, or received from database 102a and/or the account holder terminal 106, which cause it to carry out or perform various features and functionalities of the aspects of this disclosure, e.g., one or more operations discussed with respect to FIG. 2. By way of example only and not by way of limitation, the processor 102c may be an INTEL® PENTIUM® processor provided by Intel, Inc. of Santa Clara, Calif.

In one aspect of the disclosure, the memory 102d includes instructions or data associated with the rules engine 102b. In one aspect, the memory 102d could be a conventional read-writable memory known to one of ordinary skill in the art. By way of example only, the memory 102d may be non-transitory computer readable medium. In one aspect, the memory 102d may include computer executable instructions, which, when executed by the processor 102c, cause the processor 102 to carry out or perform various features and functionalities of the aspects in this disclosure, e.g., operations discussed with respect to FIG. 2.

The account holder terminal 106 may be coupled directly to the DART system apparatus 102. Alternatively, additionally, or optionally, the account holder terminal 106 may be coupled to the DART system apparatus 102 via the communication network 104. In one aspect, the account holder terminal 106 may be an integrated part of the DART system apparatus 102. The account holder terminal 106 may be a computer system or device including a display 106a, a processor 106b, a memory 106c, and an input output interface 106d. In one aspect, the account holder terminal 106 may be a laptop, a personal computer, a mobile phone or “smart” phone, a tablet computing device, or the like. The account holder terminal 106 may be used by a person or an organization holding an account with an owner or host of the DART system 102. The account holder may define the purchase rules stored in the database 102a and implemented using the rules engine 102b.

The display 106a may be a touch screen or a liquid crystal display that presents information to the user of the account holder terminal 106. For example, the display 106a may be used to view the purchase rules during creation or initial setup, management or updating of the purchase rules. Generally, the display 106a may be any visual display unit, as may be understood by one of ordinary skill in the art.

The processor 106b may be a general purpose processing unit, e.g., a microprocessor chip. The processor 106b may be configured, adapted, or programmed to transmit, receive and process code associated with the rules engine 102b in the database 102a and/or the memory 106c. In addition, the processor 106b may be configured, adapted, or programmed to carry out additional steps. The processor 106b may execute one or more instructions stored in memory 106c, or received from database 102a, which cause it to carry out or perform various features and functionalities of the aspects of this disclosure, e.g., one or more operations discussed with respect to FIG. 2. By way of example only and not by way of limitation, the processor 106b may be an INTEL® PENTIUM® processor provided by Intel, Inc. of Santa Clara, Calif.

In one aspect of the disclosure, the memory 106c includes instructions or data associated with creating, updating or managing the rules engine 102b through the account holder terminal 106. In one aspect, the memory 106c could be a conventional read-writable memory known to one of ordinary skill in the art. By way of example only, the memory 106c may be non-transitory computer readable medium. In one aspect, the memory 106c may include computer executable instructions, which when executed by the processor 106b cause it to carry out or perform various features and functionalities of the aspects in this disclosure, e.g., operations discussed with respect to FIG. 2.

The input-output interface 106d may be a keyboard, a touch screen, a push button keypad, a tracking device such as a mouse, a gesture-based interface, combinations thereof, or any other input-output interface that is configured to allow an account holder to use the account holder terminal 106. In aspect of the disclosure, the input output interface 106d may include a magnetic card reader or a radio frequency identification (RFID) reader to program data including initial purchase rules to the tendering instrument 112 directly (e.g., by swiping the tendering instrument 112 at the input output interface 160d), or indirectly via the DART system apparatus 102.

The funding system terminal 108 is a computer system that is configured to allow one or more transfers of funds or monies to finance one or more purchases carried out or services utilized using the tendering instrument 112 at the sales device 110. For example, the funding system terminal 108 may be associated with a financial institution (e.g., a bank) where the account holder at the account holder terminal 106 deposits funds or monies to finance transactions made using the tendering instrument 112. In one aspect, the funding system terminal 108 may communicate with the account holder terminal 106 directly. The funding system terminal 108 may include one or more processors, one or more memory devices, one or more input output terminals, etc. (not shown) to carry out various operations associated with funding various transactions using the tendering instrument 112. In one aspect, the funding system terminal 108 may be one or more computing devices configured to operate a line of credit provided to the account holder for operating the tendering instrument 112. Such a line of credit may be used by the host or the owner of the DART system apparatus 102 to bill the account holder for purchases made or services used by the account user using the tendering instrument 112.

The sales device 110 is a hardware device that is configured to perform transactions associated with a purchase made using the tendering instrument 112. By way of example only, and not by way of limitation, sales device 110 may be a computer terminal with an interactive interface, a Point-of-Sale (POS) device, a self-checkout terminal, or the like at which a user of the tendering instrument 112 can finalize or complete a transaction for purchase of an item or service.

In one aspect, the sales device 110 may be located at a physical “brick and mortar” type store of a merchant. Alternatively, the sales device 110 may be an online portal (e.g., a “.com” website) available to the user of the tendering instrument 112 at a computer terminal, mobile phone, a tablet, or any other computing device. The sales device 110 includes a memory 110a, a processor 110b, a tendering instrument reader 110c, and an input output interface 110d. The sales device 110 may include additional standard components such as a display, heat sinks and cooling systems, power supply, network cards, etc., known to one of ordinary skill in the art. In one aspect, the sales device 110 may be coupled to one or more servers that are owned or rented by the merchant owning or renting the sales device 110. In one aspect, the sales device 110 may be a self-checkout or a “scan and go” type of device or terminal, where no or very little assistance from the operator of the sales device 110 is required to carry out a purchase or to utilize a service.

The memory 110a may include a local database (not shown) of eligible items for purchase associated with the tendering instrument 112. In one aspect of the disclosure, the memory 110a includes instructions or data for communication with the rules engine 102b. In one aspect, the memory 110a may include a copy of the purchase rules, as received from the rules engine 102b in the database 102a. In one aspect, the memory 110a may be a conventional read-writable memory known to one of ordinary skill in the art. By way of example only, the memory 110a may be non-transitory computer readable medium. In one aspect, the memory 110a may include computer executable instructions, which when executed by the processor 102c cause it to carry out or perform various features and functionalities of the aspects in this disclosure, e.g., operations discussed with respect to FIG. 2.

The processor 110b may be a general purpose processing unit, e.g., a microprocessor chip. The processor 110b may be configured, adapted, or programmed to receive and process read code or updates to the purchase rules from the rules engine 102b in the database 102a. In addition, the processor 110b may be configured, adapted, or programmed to carry out additional steps. The processor 110b may execute one or more instructions stored in memory 110a, or received from database 102a, which cause it to carry out or perform various features and functionalities of the aspects of this disclosure, e.g., one or more operations discussed with respect to FIG. 2. By way of example only and not by way of limitation, the processor 110b may be an INTEL® PENTIUM® processor provided by Intel, Inc. of Santa Clara, Calif.

The input-output interface 110d may be a keyboard, a touch screen, a push button keypad, a tracking device such as a mouse, a gesture-based interface, or combinations thereof that is configured to a representative at the sales device 110 to assist in completing the purchase transaction using the tendering instrument 112 provided by the user.

The tendering instrument reader 110c may include a magnetic card reader, a radio frequency identification (RFID) reader, a Quick Response (QR) code reader, a barcode reader, or an electronic identification data structure (e.g., account number) associated with the tendering instrument 112 to read data from the tendering instrument 112. In one aspect, the processor 110b of the sales device 110 may identify a type of the tendering instrument 112 to determine an appropriate technique to read the tendering instrument 112. The type of the tendering instrument 112 may aid the processor 110b to configure or select the tendering instrument reader 110c to read a magnetic strip, an electronic token number, etc. from the tendering instrument 112. For example, a number associated with the tendering instrument 112 may be provided to the tendering instrument reader 110c. In one aspect, the tendering instrument reader 110c is configured to read the tendering instrument 112 by swiping the tendering instrument 112 at the input output interface 160d. In one aspect, the tendering instrument reader 110c is a graphical user interface (GUI) at the sales device 110 where identification data associated with the tendering instrument 112 may be provided to the tendering instrument reader 110c.

The tendering instrument 112 may be, but is not limited to, a magnetic card, an RFID card, a bar code, a Quick Response (QR) code, an online identifier available on a computer device to a user, or combinations thereof. Generally, the tendering instrument 112 is a device that can be configured by the organization or account holder using the account holder terminal 106. In one aspect, a provider of the tendering instrument 112 may enroll the account holder or the organization to authorize issuance of the tendering instrument 112. The tendering instrument 112 may store data associated with various eligible purchases, and may be updated at the sales device 110 and/or at the account holder terminal 106.

In one aspect, when the tendering instrument 112 is effectuated or implemented using a computing device (e.g., a QR code on a smart phone), the computing device may receive updates regarding the purchase rules from the DART system apparatus 102 via the communication network 104. For example, the tendering instrument 112 may be a tablet computer application (“app”) for purchasing various items. The user of the tendering instrument 112 may use the tendering instrument 112 app to buy items online at a merchant. In one aspect, the tendering instrument 112 may be a closed network device, which means that the tendering instrument 112 may only be used at certain merchants, as defined by the purchase rules in the rules engine 102b. Alternatively, the tendering instrument 112 may be an open network card, which means the account holder or the organization associating the purchase rules at the account holder terminal 106 may program the tendering instrument 112 to be used at any merchant. In one aspect, the tendering instrument 112 may be changed from an open network to a closed network instrument or vice versa. By way of example only and not by way of limitation, the tendering instrument 112 may be a payment device with user identification capabilities. It is to be noted that the discussion herein may pertain to a single tendering instrument 112 associated with one account user, but such discussion is not meant to be limiting. For example, multiple users or a group of users may be provided with a range of card numbers associated with respective number of tendering instruments similar to the tendering instrument 112. In one aspect, such a range may be hard coded in the memory 102d, although a dynamic programmable range of numbers for allocating a plurality of tendering instruments to multiple account users may be used. For example, the account holder may be provided a range of numbers (e.g., 20000-200000), which may be assigned using the account holder terminal 106 to multiple account users for making independent purchases or utilizing services independently of each other. This range of number may change over time, as deemed necessary by the account holder.

The communication network 104 is configured to couple the DART system apparatus 102, the account holder terminal 106, the funding system terminal 108, and the sales device 110, although in addition or alternatively, the components of the DART system 100 may be coupled to each other directly. The communication network 104 may be a wireless network, a wired network or any combination of wireless network and wired network. For example, the communication network 104 may include one or more of a fiber optics network, a passive optical network, a cable network, an Internet network, a satellite network (e.g., operating in Band C, Band Ku or Band Ka), a wireless LAN, a Global System for Mobile Communication (GSM), a Personal Communication Service (PCS), a long term evolution (LTE), a Personal Area Network (PAN), D-AMPS, Wi-Fi, Fixed Wireless Data, IEEE 802.11 or any other wired or wireless network for transmitting and receiving a data signal. In addition, the communication network 104 may include, without limitation, telephone lines, fiber optics, IEEE Ethernet 802.3, wide area network (WAN), local area network (LAN), or global network such as the Internet. The communication network 104 may support an Internet network, a wireless communication network, a cellular network, or the like, or any combination thereof. The communication network 104 may further include one, or any number of the exemplary types of networks mentioned above operating as a stand-alone network or in cooperation with each other. Although the communication network 104 is depicted as one network, it should be appreciated that according to one or more aspects, the communication network 104 may include a plurality of interconnected networks, such as, for example, a service provider network, the Internet, a broadcaster's network, a cable television network, corporate networks, and home networks.

FIG. 2 is a flow chart illustrating the features and functionality of the DART system 100 of FIG. 1, according to an aspect of the present disclosure. An exemplary method 200 may be provided by way of example only to carry out the features and functionality of the DART system 100, as there are a variety of ways to carry out the method 200. The method 200 shown in FIG. 2 can be executed or otherwise performed by one or a combination of various systems. The method 200 is described below may be carried out by the systems and networks shown in FIG. 1, by way of example, and various elements of the systems and networks are referenced in explaining the example method of FIG. 2. Each block shown in FIG. 2 represents one or more processes, methods or subroutines carried out in the exemplary method 200.

In one aspect, one or more processes or operations in the method 200 may be carried out by one or more of the processors 106b, 102c, and/or 110b of the DART system 100, or by combinations thereof. Further, one or more processes may be skipped or combined as a single process, repeated several times, and the flow of processes in the method 200 may be in any order not limited by the specific order illustrated in FIG. 2. For example, operations 216 and 220 may be moved around in terms of their respective orders, or may be carried out in parallel with one or more processes.

Referring to FIG. 2, the exemplary method 200 may begin at an operation 202. In the operation 202, the account holder or the organization at/in control of the account holder terminal 106 may enroll into a DART program, offered by the DART system 100, by communicating with the DART system apparatus 102. The term “enroll” as related to the DART system 100 indicates acceptance by the account holder or the organization wishing to provide the tendering instrument 112 to one or more authorized users of rules and regulations of the DART system 100. Such enrollment may include issuance of the tendering instrument 112 by the DART system apparatus 102. For example, the DART system apparatus 102 may allocate a unique identification number to a hardware version of the tendering instrument 112 (e.g., a gift/rewards card with a magnetic stripe). In another example, the DART system apparatus 102 may electronically provide the account holder or organization at the account holder terminal 106 with an electronic coupon or token number upon enrolment into the DART system 100. The account holder or the organization may then transmit the electronic coupon or token electronically to a mobile device of the user (not shown) for use as the tendering instrument 112 at the sales device 110.

In one aspect, still in the operation 202, upon enrolment and issuance of the tendering instrument 112, the account holder or the organization at the account holder terminal 106 may program the tendering instrument 112 with initial purchase rules, for example, selected from the rules engine 102b in the database 102a. For example, the account holder or the organization may be presented with a graphical user interface (GUI) on the display 106a where a plurality of purchase rules (e.g., those listed above) are presented. The account holder or the organization may select one or more of such purchase rules and save the selected rules in the memory 106c and/or the database 102a. These initial selected purchase rules may then be associated with one or more tendering instruments, e.g., the tendering instrument 112. As discussed, such association of the initial purchase rules may be carried out in one or more ways, e.g., swiping the tendering instrument 112 at the input/output interface 106d, transmitting the purchase rules over a wireless radio frequency or Bluetooth™ channel to the tendering instrument 112. In one aspect, the initial purchase rules associated with the tendering instrument 112 may not be stored or communicated to the tendering instrument 112 itself. Instead, a merchant renting or owning the sales device 110 at which the tendering instrument 112 is to be used may be apprised of the initial purchase rules over the communication network 104. The sales device 110 may receive these initial purchase rules from the DART system apparatus 102, specifically, from the database 102a where the initial purchase rules are associated with the tendering instrument 112 using the rules engine 102b.

In one aspect, using the rules engine 102b, the account holder or the organization at the account holder terminal 106 may associate the purchase rules for the tendering instrument 112 with one or more “in-network” merchants only. The term “in-network” relates to a predetermined list of merchants where a user of the tendering instrument 112 is allowed to make purchases or financial transactions. That is, if a particular merchant owning or renting the sales device 110 is not in the list, then the tendering instrument 112 may not be used for purchases or financial transactions at that particular merchant. Alternatively, in one aspect, using the rules engine 102b, the account holder or the organization at the account holder terminal 106 may associate the purchase rules for the tendering instrument 112 with one or more “out-of-network” merchants only. That is, if a particular merchant owning or renting the sales device 110 is not in the list, only then the tendering instrument 112 may be used for purchases or financial transactions at that particular merchant. For example, an underage user attempting to purchase alcohol from a liquor store may not be able to use the tendering instrument 112 at the liquor store if the initial purchase rules indicate the liquor store as a merchant where the tendering instrument 112 should not be used. Further, the tendering instrument 112 may be acceptable for use by any merchant but might be restricted by the initial purchase rules for a type of purchase or financial transaction that may be made at the sales device 110 of such merchant(s).

In one aspect, in an operation 204, upon enrolment and setup of the initial purchase rules, the account holder or the organization provides the tendering instrument 112 to a user who can then use the tendering instrument 112 to carry out a purchase and/or a financial transaction. The tendering instrument 112 may be provided to the user of the tendering instrument 112 physically when the user personally collects the tendering instrument 112, using postal mail, using standard electronic communication (e.g., e-mail) with the user, or using combinations thereof. Alternatively, in one aspect, the user may already be in possession of the tendering instrument 112 but may need to associate the initial purchase rules programmed by at the account holder terminal 106 prior to making a purchase or a financial transaction. As discussed, such association of the initial purchase rules may be carried out in one or more ways, e.g., swiping the tendering instrument 112 at the input/output interface 106d, transmitting the purchase rules over a wireless radio frequency or Bluetooth™ channel to the tendering instrument 112.

In an operation 206, the processor 102c may receive a request for making a purchase, a financial transaction, or for using other types of services. Such a request may arise from the tendering instrument 112 being used at the sales device 110 for executing the purchase or the financial transaction. For example, the purchase may be associated with an item and the financial transaction may be associated with a withdrawal of money at sales device 110. The request may be communicated as a data packet over the communication network 104, although other modes of digital or analog communication could be used. The processor 110b of the sales device 110 may read information from the tendering instrument 112 and may communicate the request for the purchase or the financial transaction to the processor 102c of the DART system apparatus 102 using the communication network 104.

In an operation 208, the processor 102c determines if the request received from the sales device 110 is a valid or an authorized request. For example, the processor 102c may determine whether the request coming from the sales device 110 is for a merchant that is prohibited or acceptable with respect to the user of the tendering instrument 112. In another example, to determine if the request is valid, the processor 102c may check if the tendering instrument 112 has an expired timestamp associated with it. In another example, the processor 102c may verify an identity of the user of the tendering instrument 112 upon receipt of the request in the operation 206. Information related to the identification of the user of the tendering instrument 112 may be presented to the processor 102c along with the data packet in which the request is received. Alternatively, the processor 102c may associate the request with a unique user of the tendering instrument 112 based, for example, on an identifier data structure provided with the communication for the request.

In an operation 210, if the processor 102c determines that the request received from the sales device 110 in the operation 206 is not valid or authorized, the processor 102c may communicate a signal to the sales device 110 to indicate that the request has been declined. For example, an operator of the sales device 110 may see a notification of a rejection of the request on a display (not shown) of the sales device 110, although other forms of notification, e.g., an audio signal, could be used as may be understood by one of ordinary skill in the art.

In an operation 212, if the processor 102c determines that the request received from the sales device 110 in the operation 206 is valid or authorized, the processor 102c may determine if the purchase rules associated with the request were updated since the tendering instrument 112 was last used. The processor 102c may communicate with the rules engine 102b to check for such updates to the purchase rules. The purchase rules may be updated for changes to accommodate various conditions or parameters that might have changed since the initial set up of the purchase rules (e.g., in the operation 202). For example, the age of the user of the tendering instrument 112 might have changed since the initial setup such that the user may be above the legal age limit for purchasing alcohol. So, the purchase rules in the rules engine 102b may be updated by the account holder or the organization to reflect such a change. Further, by way of example only and not by way of limitation, some other updates to the purchase rules associated with the tendering instrument 112 using the rules engine 102b may include updates to one or more of a category of an item for purchasing, a time period for purchasing the item, a method of payment for purchasing the item, an award or a discount value associated with the purchase, a list of prohibited items, a monetary limit imposed on the purchase, a number of items for purchasing, or identification information for the requester (i.e., the user), or combinations thereof. In this respect, the tendering instrument 112 associated with the user or the requester of the purchase may dynamically receive updates to the purchase rules associated with the tendering instrument 112, as and when the purchase rules are updated. That is, the purchase rules may change dynamically and may be different from the initial purchase rules set up by the account holder or the organization at the account holder terminal 106. Further, the purchase rules may change flexibly for each purchase or financial transaction carried out using the tendering instrument 112 and may vary from merchant to merchant, in-network or out-of-network. Advantageously, unlike conventional systems, as the purchase rules are updated, there is no need for the account holder or the organization enrolled with the DART system 100 to use a new tendering instrument for each update. Thus the same tendering instrument (e.g., the tendering instrument 112) can be used flexibly and dynamically in real-time (during the time the request is being processed) to allocate updates to the purchase rules for the user or the requester of the purchase or the financial transaction leading to faster implementation of such purchase rules and lowering overhead account costs associated with separate new tendering instruments.

In an operation 214, if the purchase rules associated with the tendering instrument 112 have been updated, the processor 102c may apply the updated purchase rules to the request received from the sales device 110. For example, the processor 102c may send the determination of the updated purchase rules to the processor 110b of the sales device to locally store such updates to the purchase rules in the memory 110a of the sales device 110 until a next request for a purchase of an item or for a financial transaction is received from the tendering instrument 112 at the sales device 110.

In an operation 216, upon application of the updated purchase rules, the processor 102c may determine whether or not to allow the request for purchase or financial transaction at the sales device 110. If not, the request is declined in the operation 210, as discussed. If yes, the flow proceeds to an operation 218.

In the operation 218, the processor 102c may communicate a signal to the sales device 110 to indicate that the request has been approved. For example, an operator of the sales device 110 may see a notification of an approval of the request on a display (not shown) of the sales device 110, although other forms of notification, e.g., an audio signal, could be used as may be understood by one of ordinary skill in the art. The operator of the sales device 110 may then complete the request for the purchase or the financial transaction by providing the item for purchase or a requested financial instrument (e.g., cash, cash rewards points) to the user of the tendering instrument 112. In the case of an online transaction, where the sales device 110 is part of a computer system being used for an online purchase, the user of the tendering instrument 112 may directly receive such a notification of approval and completion of the request.

In an operation 220, the processor 102c may update database 102a regarding details of the purchase or the financial transaction. For example, the processor 102c may indicate whether or not the transaction was successfully executed. The account holder or the organization may then see the results of the transaction at the display 106a of the account holder terminal 106. Additionally or alternatively, the processor 102c may communicate financial information associated with the purchase or the financial transaction to the funding system terminal 108. For example, the processor 102c may indicate a monetary value associated with the request for the purchase or the financial transaction. If the request was approved, a balance financial amount may be updated at the funding system terminal 108 to account for the purchase or the financial transaction. Accordingly, the account holder or the organization may then add funds or view the balance funds by communicating with the funding system terminal 108 from the account holder terminal 106 directly or via the communication network 104.

The DART system apparatus 102 implements dynamic updates to the purchase rules using the rules engine 102b as payment occurs at the sales device 110 (e.g., a POS device) for purchasing items rather than reimbursement in batch after the purchase has been executed. The DART system 100 is dynamic by allowing the account holder or the organization to change purchase rules at any time even after initial set up using the account holder terminal 106 in communication with the rules engine 102b of the DART system apparatus 102. In one aspect, the account holder or the organization may program the tendering instrument 112 to set events in motion in advance before they happen, i.e., set purchase rules and update them flexibly prior to a purchase request or a financial request by the user of the tendering instrument 112. As discussed, the tendering instrument 112 may be controlled by the account holder or the organization and used by the user through a mobile app, a kiosk, a web site, or combinations thereof.

Various examples of purchase rules that may be controlled and updated include, but are not limited to, limiting how much money is spent using the tendering instrument 112, what quantity of items may be purchased, and which process method may be used (e.g., gift card, mobile payment, e-gift card, other financial account, automated or manual fund transfers), or which channel may be used such as VIPS™ (restaurant in Mexico) on-line, Sam's Club™, Walmart™, Massmart™, ASDA™, or any domestic or international line of business or financial products.

The rules engine 102b may associate an occasion (triggering event) for release of funds. For example, events such as Christmas, Mother's Day, birthdays, graduation, allowance, or payday that could be set up in advance for the user of the tendering instrument 112. Similarly, the rules engine 102b may be used to program the tendering instrument 112 for usage in terms of parameters such as what time(s) of day, day(s) of week, day(s) of month, day(s) of year, etc. and update the rules associated with such parameters.

The rules engine 102b may be used to determine who is the user or recipient using the tendering instrument 112, which could be more than one person. In one aspect, the user or the recipient may be required to provide a picture identification for executing the purchase or the financial transaction. Further, the rules engine 102b may be used to restrict a location or geography (e.g., city, state, etc.) where the tendering instrument 112 may be used, and may change such locations dynamically, e.g., when the user travels. In one aspect, as discussed, the rules engine 102b may be used to create and update purchase rules associated with what is allowed for purchase, or restricted product, item, fine line, department, product characteristic (e.g., alcohol, peanuts, salt, tobacco, sugar, etc.).

In certain exemplary use cases, parents may give a card as the tendering instrument 112 to a child and determine the child can only buy one pair of gym shoes for school on Saturday at only the local store. The dollar amount may not be limited for the recipient but the item and quantity is limited. The dollar amount would only be limited by the parents' account balance but not the tendering instrument 112 itself. In one scenario, a church's food-bank gives cards (similar to the tendering instrument 112) out to some resident who experienced a hardship such as, but not limited to, a fire, a hurricane, or other disaster and they can only buy food and water items with a limit of $50 a week during normal business hours and the church wishes to see what was purchased. Likewise, churches or charity organizations could set up using the account holder terminal 106 in advance for amounts, frequencies, and other conditions where people could get money for special occasions in addition to other times. The church would not have to constantly maintain funds but could set a dynamic plan in motion based upon frequency and special dates. The church could also sign on and add or subtract amounts anytime they like and such changes or updates would immediately be applied to the tendering instrument 112.

In another scenario, employers could set up bonuses or other rewards for employees in advance. The advance payouts to employees could be easily adjusted by the employer using the rules engine 102b. For example, birthdays, employment anniversaries, bonuses, and any other incentive could be preprogrammed by the employer for payout to the employee. Likewise, charities could set restrictions on their participants' purchase time of day or day of week restricting to daylight hours or whatever their need is. They could also flexibly and dynamically restrict what is purchased, how many, and how much is spent using the tendering instrument 112.

The many features and advantages of the disclosure are apparent from the detailed specification, and thus, it is intended by the appended claims to cover all such features and advantages of the disclosure which fall within the true spirit and scope of the disclosure. Further, since numerous modifications and variations will readily occur to those skilled in the art, it is not desired to limit the disclosure to the exact construction and operation illustrated and described, and accordingly, all suitable modifications and equivalents may be resorted to, falling within the scope of the disclosure.

What is claimed is:

1. A dynamic awards and restrictive tender method, comprising:
receiving, at a processor of a sales device, a request for a purchase of an item;
determining a purchase rule applicable to the purchase;
receiving an update to the purchase rule;
processing the request for the purchase based upon the updated purchase rule; and
providing, at the processor, a notification of a success or a rejection of the processed request for the purchase to a requester initiating the request.

2. The dynamic awards and restrictive tender method of claim 1, wherein the receiving the update to the purchase rule occurs prior to or during the processing of the request.

3. The dynamic awards and restrictive tender method of claim 1, wherein the request for the purchase is presented to the sales device using a tendering instrument and the purchase rule and/or the update to the purchase rule is configured to be created and/or modified by an account holder of the tendering instrument.

4. The dynamic awards and restrictive tender method of claim 1 further comprising:
communicating, from the processor, the notification to an account holder of a tendering instrument used for the purchase.

5. The dynamic awards and restrictive tender method of claim 4, wherein the tendering instrument is at least one of a card and an electronic account number.

6. The dynamic awards and restrictive tender method of claim 1, wherein the receiving the update comprises receiving updates regarding changes to one or more of:
a category of the item for purchasing;
a time period for purchasing the item;
a method of payment for purchasing the item;
an award or a discount value associated with the purchase;
a list of prohibited items;
a monetary limit imposed on the purchase;
a number of items for purchasing; and
identification information for the requester.

7. The dynamic awards and restrictive tender method of claim 1 further comprising:
communicating, from the sales device, charges associated with the purchase to an account holder associated with the requester.

8. The dynamic awards and restrictive tender method of claim 1, wherein the purchase rule is part of a rules engine programmable by an account holder of an instrument being used for the purchase by the requester.

9. A dynamic awards and restrictive tender system, comprising:
a database including:
an account associated with an account holder;
a rules engine including a plurality of purchase rules dynamically programmable by the account holder, the rules engine configured to determine a purchase rule applicable to a request for a purchase; and
a sales device configured to execute the purchase requested by a requester, the sales device comprising a processor configured to:
receive the request for a purchase of an item;
receive an update to the purchase rule from the rules engine;
process the request for the purchase based upon the updated purchase rule; and
receive a notification of a success or a rejection of the processed request for the purchase to the requester at the sales device.

10. The dynamic awards and restrictive tender system of claim 9, wherein the rules engine is configured to be updated by the account holder prior to or while the request is being processed by the processor.

11. The dynamic awards and restrictive tender system of claim 9, wherein the processor is further configured to:
communicate the notification to the account holder.

12. The dynamic awards and restrictive tender system of claim 9, wherein the sales device is at least one of a Point-of-Sales (POS) terminal and a computer, and the tendering instrument is at least one of a card and an account number.

13. The dynamic awards and restrictive tender system of claim 9, wherein the processor is configured to receive the update to the purchase rule including changes to one or more of:
a category of the item for purchasing;
a time period for purchasing the item;
a method of payment for purchasing the item;
an award or a discount value associated with the purchase;
a list of prohibited items;
a monetary limit imposed on the purchase;
a number of items for purchasing; and
identification information for the requester.

14. The dynamic awards and restrictive tender system of claim 9, wherein the processor is further configured to:
apply, at the sales device, charges associated with the purchase to an account holder.

15. A computer readable medium storing computer executable instructions thereupon for dynamic awarding and restrictive tendering, the instructions when executed by a processor cause the processor to:
receive a request for a purchase of an item;
receive a purchase rule applicable to the request for the purchase;
receive an update to the purchase rule from an account holder;
process the request for the purchase based upon the updated purchase rule; and
provide a notification of a success or rejection of the processed request for the purchase to the requester at a sales device.

16. The computer readable medium of claim 15, wherein the instructions, when executed by the processor, cause the processor to receive the update to the purchase rule prior to or during the processing of the request.

17. The computer readable medium of claim 15, wherein the request for the purchase is presented to the sales device using a tendering instrument and the purchase rule and the update to the purchase rule is created and modified by the account holder of the tendering instrument.

18. The computer readable medium of claim 15, wherein the instructions, when executed by the processor, further cause the processor to:
communicate, from the processor, the notification to the account holder of a tendering instrument used for the purchase.

19. The computer readable medium of claim 15, wherein the processor receives the update by receiving updates regarding changes to one or more of:
a category of the item for purchasing;
a time period for purchasing the item;
a method of payment for purchasing the item;
an award or a discount value associated with the purchase;
a list of prohibited items;
a monetary limit imposed on the purchase;
a number of items for purchasing; and
identification information for the requester.

20. A dynamic rewards and restrictive tender method, comprising:
associating one or more initial purchase rules with a tendering instrument used for making a purchase at a merchant;
receiving a request for the purchase;
receiving dynamically, at the processor, an update to a purchase rule applicable to the purchase;
processing the request for the purchase based upon the updated purchase rule; and
providing a notification of a success or a rejection of the processed request for the purchase to a requester initiating the request.
